(19) United States
(12) Patent Application Publication
(10) Pub. No.: US 2010/0133298 A1
(43) Pub. Date: Jun. 3, 2010

(54) APPARATUS COMPRISING A COOLING DEVICE FOR AT LEAST ONE BAG-IN-BOX PACKAGE

(76) Inventors: Rainer Samson, Muenster (DE); Amit Roy, Papenburg (DE)

Correspondence Address: COLLARD & ROE, P.C., 1077 NORTHERN BOULEVARD, ROSLYN, NY, 11576, US

(21) Appl. No.: 12/452,092

(22) PCT Filed: Feb. 19, 2008
(86) PCT No.: PCT/DE08/00289

§ 371 Date: Jan. 5, 2010

(30) Foreign Application Priority Data
Feb. 22, 2007 (DE) 20 2007 002 623.4

(51) Int. Cl. B67D 7/80; B67D 7/08; B65D 35/56; B67D 7/06

(52) U.S. Cl. 222/146.6; 222/105; 222/183; 222/505

(57) ABSTRACT

Disclosed is an apparatus comprising a cooling device for at least one bag-in-box package, a feed hole for the bag-in-box package, at least one device door that closes the feed hole, and at least one beverage outlet which can be associated with the tapping valve of the bag-in-box package. The beverage outlet is disposed within the device door.

The invention relates to an apparatus comprising a cooling device for at least one bag-in-box package, comprising a feed hole for the bag-in-box package comprising at least one device door which closes the feed hole and comprising at least one beverage outlet which can be associated with the tapping valve of the bag-in-box package.

Known apparatus are also designated as dispensers which are set up for providing chilled drinks at breakfast buffets and self-service counters. The known apparatus has the goal of extending the keeping properties of bag-in-box packages which have been broken into by chilling. However, the known apparatus has the disadvantage that germs and bacteria can migrate from the beverage outlets via piping parts into the bag-in-box packages and the beverages perish prematurely. In the known apparatus therefore, regular and work-intensive cleaning measures of all the piping parts are therefore required.

It is therefore the object of the invention to provide an apparatus of the genre specified initially for which the cleaning expenditure is reduced appreciably.

This object is achieved according to the invention by an apparatus having the features of patent claim 1. Advantageous further developments of the invention are specified in the dependent claims.

The apparatus according to the invention is characterised in that the beverage outlet is disposed within the device door. By simply opening the device door, the tapping valve and the beverage outlet are automatically separated from one another so that all the piping parts are exposed and cleaning measures are substantially simplified.

According to a first further development of the invention, the beverage outlet is configured as a housing opening surrounding a beverage jet in a noncontact manner. Thus, germs or bacteria transferred to the housing opening, for example, by hands or used beverage cups cannot enter into the bag-in-box package. The keeping properties of the beverage contained in the bag-in-box packages are appreciably lengthened. Thus, the apparatus according to the invention advantageously satisfies the stringent hygiene standard known in Europe “Hazard Analysis Critical Control Point” HACCP.

According to a next further development of the invention, the device door has at least one tap recess in which the beverage outlet is disposed. The tap recess advantageously makes it possible to place a drinking vessel on a draining surface. Naturally, the beverage outlet is preferably disposed in the upper boundary of the tap recess so that a beverage jet can pass through the beverage outlet in the vertical direction.

In order to ensure that the beverage jet passes through the beverage outlet in a noncontact manner, the cooling device has at least one valve receiving bearing disposed in the area of its feed hole which is provided for receiving the tapping valve disposed on the bag-in-box package. If the cooling device is designed for the concomitant tapping of beverages from a plurality of bag-in-box packages, it naturally has a plurality of valve receiving bearings disposed in the area of its feed hole.

Furthermore, the valve receiving bearing has at least one lock for securing the position of the tapping valve. With the lock, the tapping valve is enclosed in the valve receiving bearing so that transport-induced vibrations of the apparatus according to the invention advantageously cannot result in the tapping valve being moved out from the valve receiving bearing.

According to a next further development of the invention, the cooling device has at least one valve actuating mechanism which passes through its device door. With this mechanism, beverages can be tapped on the apparatus according to the invention without needing to open the device door for this purpose. On the outer side of the device door, the valve actuating mechanism advantageously forms a button which is provided for the user-friendly introduction of an actuating force. The actuating force is passed via the valve actuating mechanism through the device door into the interior of the cooling device as far as the tapping valve.

The valve receiving bearing and the valve actuating mechanism are thus guided forcibly moveably towards one another via the linkage of the device door. The separation of the valve receiving bearing and the valve actuating mechanism which is usually necessary for exchanging empty bag-in-box packages is effected by simply opening the device door, the linkage of the device door preferably being produced by means of hinges. In principle, however, it is also feasible to configure the device door as a sliding door or as a flap.

The valve actuating mechanism advantageously has a tilting lever mounted rotatably in the device door. By means of a suitable arrangement of the tilt lever, the force transmission ratio of the tilt lever can be adjusted in such a manner that the operating comfort of the apparatus according to the invention is greater than that of the tapping valve on a commercially available bag-in-box package.

Furthermore, the valve actuating mechanism has at least one restoring spring assigned thereto. This supports the spring disposed in the tapping valve so that the automatic closure of the tapping valve after introducing an actuating force takes place rapidly and reliably. The restoring spring is, for example, configured as a leaf spring supported on the device door.

According to a particularly advantageous further development of the invention, when the device door is closed, the valve actuating mechanism has guiding surfaces which project into the valve receiving bearing. The guiding surfaces form a type of centring aid and serve to reliably produce a play-free operative connection between the tapping valve received in the valve receiving bearing and the valve actuating mechanism.

According to a particularly preferred further development of the invention, the valve actuating mechanism is configured in such a manner that it is suitable for actuating a Vitop dispenser valve. In addition, if the contact zone of the valve actuating mechanism contacting the tapping valve has the form of an open-ended spanner, which can be positioned both underneath the finger tabs associated with the closure element of the tapping valve and above these finger tabs, the apparatus according to the invention advantageously has two operating states. If the device door is closed when the valve actuating mechanism is triggered, so that the contact zone configured in the manner of an open-ended spanner projects above the finger tabs into the valve receiving bearing, the tapping mechanism is deactivated. An unauthorised dispensing of beverages can advantageously be prevented with an additional locking of the device door. If the device door is closed when the valve actuating mechanism is not triggered, so that the contact zone configured in the manner of an open-ended spanner projects below the finger tabs into the valve receiving bearing, the tapping mechanism is activated.

An exemplary embodiment of the invention from which further inventive features are deduced is shown in the drawings. In the figures:

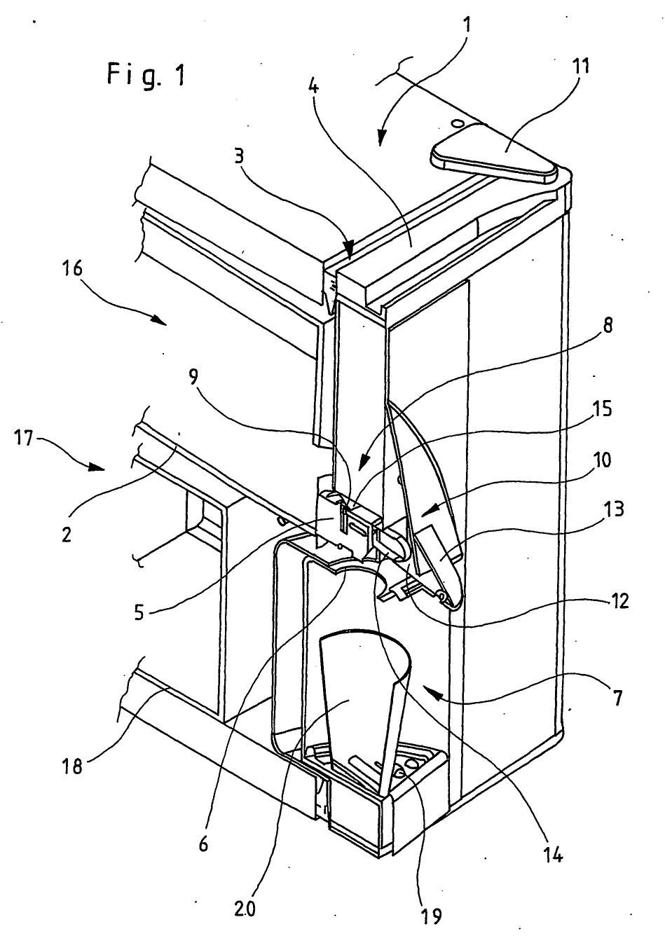

FIG. 1 shows a perspective view of the apparatus according to the invention in median cross-section and

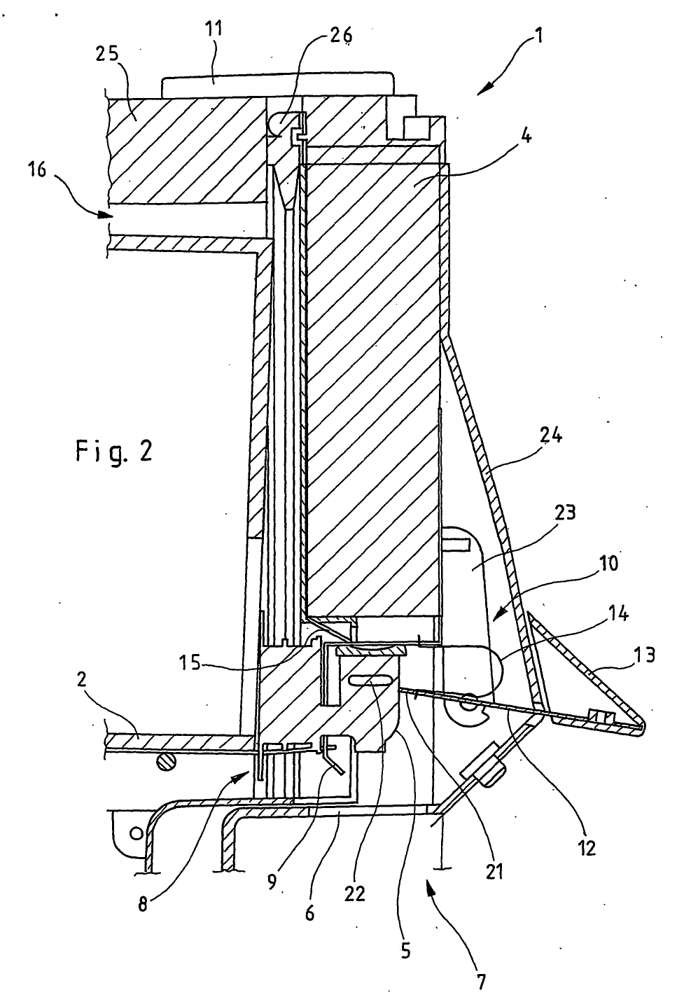

FIG. 2 shows an enlarged side view of the median cross-section according to FIG. 1.

FIG. 1 shows a perspective view of the apparatus according to the invention in median cross-section comprising a cooling device 1 which holds a bag-in-box package 2. The cooling device has a feed hole 3, a device door 4 which closes the feed hole 3 and a beverage outlet 6 which can be associated with the tapping valve 5 of the bag-in-box package 2, which is disposed within the device door 4. The beverage outlet 6 is configured as a housing opening surrounding a beverage jet, which is disposed at the top of a tapping bay 7. The cooling device 1 furthermore has a valve receiving bearing 8 disposed in the area of its feed hole 3 in which the tapping valve 5 is secured with a lock 9. In order that the tapping valve 5 can be actuated when the device door 4 is closed, the cooling device 1 has a valve actuating mechanism 10 which passes through its device door 4. The valve receiving bearing 8 and the valve actuating mechanism 10 are forcibly movably guided towards one another by means of the linkage 11 of the device door 4. The valve actuating mechanism 10 has a tilting lever 12 mounted rotatably in the device door 4 with a tapping button 13 and a restoring spring 14. In addition, when the device door 4 is closed, the valve actuating mechanism 10 has guiding surfaces 15 which project into the valve receiving bearing 8 which run on the tapping valve 5 on closing the device door 4. The tapping valve 5 is a commercially available Vitop dispenser valve. For receiving the bag-in-box package 2 the cooling device 1 has a first receiving chamber 16 with an inclined standing area. In addition, the cooling device 1 has a second receiving chamber 17 in which another bag-in-box package 18 is pre-chilled and supplied. At the bottom the tap recess 7 has a draining surface 19 on which a drinks cup 20 is placed in such a manner that a beverage jet passing through the beverage outlet 6 in a noncontact manner is intercepted by the drinks cup 20.

FIG. 2 shows an enlarged side view of the median section according to FIG. 1. In this view it is clear that the tilting lever 12 has a contact zone 21 configured in the manner of an open-ended spanner which abuts against the finger tabs 22 of the tapping valve 5 at the bottom. The tilting lever 12 is mounted on a retaining plate 23 attached to the device door 4, which is multiply angled and forms the guiding surface 15 on the inner side of the device door. Further oppositely angled guiding surfaces form the free arm ends of the contact zone 21 formed in the manner of an open-ended spanner. The device door 4 has a facing shell 24 which partially clads the valve actuating mechanism 10 and lines the tap recess 7. A seal 26 is located between the body 25 of the cooling device 1 and the device door 4. The same components are provided with the same reference numerals.

1. An apparatus comprising a cooling device (1) for at least one bag-in-box package (2) comprising a feed hole (3) for the bag-in-box package (2) comprising at least one device door (4) which closes the feed hole (3) and comprising at least one beverage outlet (6) which can be associated with the tapping valve (5) of the bag-in-box package (2), wherein the beverage outlet (6) is disposed within the device door (4).

2. The apparatus according to claim 1, wherein the beverage outlet (6) is configured as a housing opening surrounding a beverage jet in a noncontact manner.

3. The apparatus according to claim 1, wherein the device door (4) has at least one tap recess (7) in which the beverage outlet (6) is disposed.

4. The apparatus according to claim 1, wherein the cooling device (1) has at least one valve receiving bearing (8) disposed in the area of its feed hole (3).

5. The apparatus according to claim 4, wherein the valve receiving bearing (8) has at least one lock (9) for securing the position of the tapping valve (5).

6. The apparatus according to claim 1, wherein the cooling device (1) has at least one valve actuating mechanism (10) which passes through its device door (4).

7. The apparatus according to claim 6, wherein the valve receiving bearing (8) and the valve actuating mechanism (10) are guided forcibly moveably towards one another via the linkage (11) of the device door (4).

8. The apparatus according to claim 6, wherein the valve actuating mechanism (10) has a tilting lever (12) mounted rotatably in the device door (4).

9. The apparatus according to claim 6, wherein the valve actuating mechanism (10) has at least one restoring spring (14) assigned thereto.

10. The apparatus according to claim 6, wherein when the device door (4) is closed, the valve actuating mechanism (10) has guiding surfaces (15) which project into the valve receiving bearing (8).

11. The apparatus according to claim 6, wherein the valve actuating mechanism (10) is configured in such a manner that it is suitable for actuating a Vitop dispenser valve.
